(19) United States
(12) Patent Application Publication
(10) Pub. No.: US 2010/0196731 A1
(43) Pub. Date: Aug. 5, 2010

(54) VINYL ALCOHOL POLYMER-CONTAINING COATING AGENT FOR PAPER AND PAPER AND THERMAL PAPER COATED WITH THE COATING AGENT

(75) Inventors: Atsushi Jikihara, Okayama (JP); Masato Nakamae, Okayama (JP); Kazuki Nakagawa, Wakayama (JP); Koji Hori, Wakayama (JP); Misa Watanabe, Wakayama (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KURARAY CO., LTD., Kurashiki-shi, Okayama (JP)

(21) Appl. No.: 12/679,933

(22) PCT Filed: Sep. 19, 2008
(86) PCT No.: PCT/JP08/66979

§ 371 Date: Mar. 25, 2010

(30) Foreign Application Priority Data
Sep. 27, 2007 (JP) 2007-252553

(51) Int. Cl. B32B 27/10; C08L 29/04

(52) U.S. Cl. 428/511; 524/555

(57) ABSTRACT

A vinyl alcohol polymer-containing coating agent for paper is provided that allows a curing step to be omitted after a paper surface is coated therewith and makes it possible to form a layer (for example, a coating layer or a color developing layer) that is excellent in water resistance and is subjected to less yellowing over time. It is an aqueous composition containing a vinyl alcohol polymer (A) in which the content X of vinyl alcohol units (mol %) and the content Y of ethylene units (mol %) satisfy a formula X+0.2Y>95, where X<99.9 and 0≦Y≦10, and an addition condensate (B) between ethylene urea and glyoxal in which the content of terminal aldehyde groups per gram of solid content is 1.2 to 3.0 (mmol), wherein the solid content weight ratio between the vinyl alcohol polymer (A) and the addition condensate (B) is in a range of (A):(B)=99:1 to 50:50.

### TECHNICAL FIELD

The present invention relates to a coating agent for paper containing a vinyl alcohol polymer as well as paper and thermal paper coated with the coating agent.

### BACKGROUND ART

A vinyl alcohol polymer (hereinafter also referred to simply as a “PVA”) has performances unsurpassed by other water-soluble resins in terms of its film-forming properties and adhesiveness (for example, adhesion strength). Thus, it is used widely for various binders, adhesives, or surface treatment agents. One of the applications of the PVA is a coating agent for paper aimed at, for example, improving paper surface strength. Paper having a PVA coated surface is used as, for example, printing paper. The PVA contains modified polyvinyl alcohol having a constituent unit other than a vinyl alcohol unit, for example, an ethylene unit.

There are various types of paper printing methods. The current mainstream method is offset printing. In offset printing, a nonimage area and an image area are formed in a metal plate, and dampening water and ink are placed on the nonimage area and the image area, respectively. Thereafter, these are transferred by contact to a rubber blanket and further are transferred from the blanket to a paper surface to form an image. Therefore, printing paper that is used for offset printing is required to have water resistance to dampening water. The PVA itself, however, is water soluble and is poor in water resistance. Accordingly, a coating agent formed of a combination of a PVA and a crosslinker (a water resistant agent) is used in general.

The PVA is also used for a coating layer (an overcoat layer or a backcoat layer) of a thermal recording material such as thermal paper, or a binder of a color developing layer (a pigment layer or a dye layer) based on its excellent film-forming properties and adhesiveness. Generally, a leuco dye is often used as a coloring source for the thermal recording material. However, such a recording material has poor stability of recorded images. For example, contacts between the thermal recording surface and fats or a plasticizer contained in a plastic film cause color fading of the images or discoloring of the ground part (the nonimage area). The coating layer has effects of preventing such color fading and discoloring and improving the stability of images. Generally, a PVA modified by a carboxyl group is used for the coating layer. However, the carboxyl group-modified PVA tends to dissolve in water. Thus, it is necessary that the PVA is combined with a crosslinker to form a coating agent, and that thermal paper is coated with the coating agent, dried, and subjected to a curing step. The curing step is a step for allowing a formed coating layer to attain a desired waterproof level by storing the paper coated with the coating agent under an environment of 30 to 40° C. for a period of about one day to one week. In order to carry out the curing step, a storage place with a large area is required, and the curing step is a major factor in reducing the production efficiency of the thermal recording material. Accordingly, there is a need for a coating agent that allows the curing step to be omitted.

In order to improve this disadvantage, i.e. poor water resistance, of the PVA, various methods have been studied until now.

A method of combining a PVA and glyoxal to be used as a crosslinker to form a coating layer on printing paper has been known widely. In this method, the PVA can be cross-linked at a comparatively low temperature and the resultant coating layer can be provided with water resistance. However, this method has a disadvantage in that the coating layer turns yellow over time.

JP 8-269289 A discloses a water resistant composition containing an ethylene-modified PVA, a chitosan compound, and a polyaldehyde compound. However, in the case of the composition disclosed in JP 8-269289 A, a chitosan compound and a polyaldehyde compound are used as water resistant agents. Therefore, when exposed to the air for a long time, a layer formed of the composition turns yellow, which is a disadvantage. JP9-66666 A discloses a recording material in which a crosslinker and an ethylene-modified PVA with a specific constitution (with a syndiotacticity of at least 55 mol % in terms of syndiotactic diad content and a degree of saponification of at least 85 mol %) are used as a binder of a color developing layer. JP 11-208115 A discloses a thermal recording material in which an ethylene-modified PVA and a compound containing at least two aziridine groups to be used as a crosslinker are used for an overcoat layer. However, the combination of the ethylene-modified PVA and the crosslinker disclosed in each of JP 9-66666 A and JP 11-208115 A cannot always provide sufficient water resistance.

### DISCLOSURE OF INVENTION

With these problems in mind, the present invention is intended to provide a coating agent for paper that is a vinyl alcohol polymer-containing coating agent for paper, that allows a curing step to be omitted after a paper surface is coated therewith, and that makes it possible to form a layer (for example, a coating layer or a color developing layer) that is excellent in water resistance and is subjected to less yellowing over time.

As a result of dedicated studies, the present inventors found that a PVA and a crosslinker allowed to have specific compositions made it possible to obtain such a coating agent for paper.

That is, the coating agent for paper of the present invention contains; a vinyl alcohol polymer (A) in which the content X of vinyl alcohol units (mol %) and the content Y of ethylene units (mol %) satisfy the following formula (1):

X+0.2Y>95 (1)

where X<99.9 and 0≦Y<10; and
an addition condensate (B) between ethylene urea and glyoxal in which the content of terminal aldehyde groups per gram of solid content is 1.2 to 3.0 (mmol), wherein the solid content weight ratio between the vinyl alcohol polymer (A) and the addition condensate (B) is in a range of (A):(B)=99:1 to 50:50.

Paper of the present invention is paper whose surface is coated with the above-mentioned coating agent for paper of the present invention.

Thermal paper of the present invention is thermal paper whose surface is coated with the above-mentioned coating agent for paper of the present invention.

According to the present invention, since the coating agent for paper contains a PVA (A), in which the content X of vinyl alcohol units and the content Y of ethylene units are in the specific ranges, and an addition condensate (B) between ethylene urea and glyoxal, in which the content of terminal aldehyde groups is in a specific range, the coating agent for paper can be obtained that allows a curing step to be omitted after a paper surface is coated therewith and that makes it possible to form a layer (for example, a coating layer or a color developing layer) that is excellent in water resistance and is subjected to less yellowing over time.

The paper and thermal paper of the present invention are those with surfaces coated with the aforementioned coating agent for paper of the present invention and can be produced, for example, with the curing step being omitted that is conventionally required for improving water resistance of the layer (for example, a coating layer or a color developing layer) formed by application of a coating agent. Furthermore, the paper and thermal paper each can have a layer (for example, a coating layer or a color developing layer) that is excellent in water resistance and is subjected to less yellowing over time. That is, the paper and thermal paper of the present invention are excellent in, for example, water resistance, image record retention properties, plasticizer resistance, and productivity, and can be used suitably for various printing methods including offset printing and thermal printing.

### DESCRIPTION OF THE PREFERRED EMBODIMENTS

Hereinafter, the layer that is formed by application of a coating agent for paper to a paper surface is referred to simply as a “layer”. Examples of this layer include the aforementioned coating layer and color developing layer (in the color developing layer, generally, the coating agent for paper serves as a binder of a pigment or dye). However, the layer is not particularly limited to these two types of layers.

### [PVA (A)]

The PVA (A) is not particularly limited as long as it is a polyvinyl alcohol polymer that satisfies the following formula (1):

X+0.2Y>95 (1),

where X denotes the content (mol %) of vinyl alcohol units in the PVA (A) and Y denotes the content (mol %) of ethylene units in the PVA (A). X and Y are numerical values that satisfy formulae X<99.9 and 0≦Y<10, respectively.

The content X of vinyl alcohol units in the PVA (A) (this also can be referred to as the degree of saponification of the PVA (A)) is required to be less than 99.9 mol % and is preferably 99.8 mol % or less and further preferably 99.7 mol % or less. When the content X is 99.9 mol % or more, the viscosity stability of the coating agent is deteriorated and a practical coating agent cannot be obtained. Furthermore, the content X is preferably 95 mol % or more, more preferably 98.5 mol % or more, and further preferably 99 mol % or more. That is, the content X is preferably at least 95 mol % but less than 99.9 mol %, more preferably 98.5 to 99.8 mol %, and further preferably 99 to 99.7 mol %. When the content X is in these ranges, a layer that is further excellent in water resistance can be formed.

The PVA (A) has ethylene units, that is, it is preferable that the content Y of the ethylene units in the PVA (A) exceed 0 mol % (for example, 0<Y<10). In this case, a layer that is further excellent in water resistance can be formed.

The content Y of the ethylene units in the PVA (A) is required to be less than 10 mol % and is preferably 1 to 9 mol % and more preferably 3 to 8 mol %. When the content Y is 10 mol % or more, water solubility of the PVA (A) is added and thereby it is difficult to form the coating agent and the viscosity stability of the coating agent may be deteriorated.

The content Y in the PVA (A) can be determined by a known method. For example, it may be determined by carrying out ¹H-NMR (proton nuclear magnetic resonance) measurement with respect to a vinyl ester polymer, which is a precursor of the PVA. A specific example follows. Purification by reprecipitation is carried out at least three times using an n-hexane/acetone mixed solution with respect to a vinyl ester polymer, which is a measuring object. Next, the polymer thus purified is dried under reduced pressure at 80° C. for three days. Subsequently, the well dried polymer is dissolved in DMSO-d₆ (deuterated dimethyl sulfoxide) and ¹H-NMR is performed to the polymer at 80° C. The content Y can be determined from the peak (with a chemical shift of 4.7 to 5.2 ppm) derived from methine that is present in the main chain of the vinyl ester unit and the peak (with a chemical shift of 0.8 to 1.6 ppm) derived from methylene that is present in the main chains of the vinyl ester unit and ethylene unit in the measured profile.

Preferably, the PVA (A) satisfies the following formula (2) with respect to the above-mentioned contents X and Y, because in this case a layer can be formed that is further excellent in water resistance and that further is prevented from yellowing over time:

X+0.2Y>98.5 (2)

where X and Y are numerical values that satisfy formulae X<99.9 and 0≦Y<10, respectively.

Generally, the PVA (A) can be obtained by polymerizing vinyl ester monomers, such as vinyl acetate, individually or together with ethylene by a known polymerization method (for example, bulk polymerization, solution polymerization using a solvent such as methanol, emulsion polymerization, or suspension polymerization), and then saponifying the resultant polymer by various saponification methods (for example, alkali saponification, acid saponification, or alcoholysis). The vinyl ester monomers that can be used in addition to the aforementioned vinyl acetate include various monomers such as vinyl formate, vinyl propionate, vinyl valerate, vinyl caprate, vinyl laurate, vinyl stearate, vinyl benzoate, vinyl versatate, and vinyl pivalate, but it is preferable that vinyl acetate be used.

The degree of polymerization (determined by viscosity average molecular weight) of the PVA (A) is not particularly limited but generally is about 200 to 4000, preferably about 250 to 3000, and particularly preferably about 300 to 2000. When the degree of polymerization of the PVA is lower than 200, a layer with sufficient water resistance and plasticizer resistance may not be formed. On the other hand, when the degree of polymerization of the PVA exceeds 4000, the viscosity of the coating agent may increase excessively and the coating properties thereof may deteriorate. The degree of polymerization of the PVA (A) can be evaluated based on the provision of JIS-K6726 (The test methods for polyvinyl alcohol).

The PVA (A) may contain a constituent unit derived from a monomer that can be copolymerized with the vinyl ester monomer and ethylene within the range where the effects of the present invention are not impaired. Examples of such a monomer include alpha-olefins such as propylene, 1-butene, isobutene, and 1-hexene; vinyl ethers such as methyl vinyl ether, ethyl vinyl ether, n-propyl vinyl ether, i-propyl vinyl ether, and n-butyl vinyl ether; hydroxyl group-containing vinyl ethers such as ethylene glycol vinyl ether, 1,3-propanediol vinyl ether, and 1,4-butanediol vinyl ether; allyl acetate; allyl ethers such as propyl allyl ether, butyl allyl ether, and hexyl allyl ether; monomers containing an oxyalkylene group; vinyl silanes such as vinyltrimethoxysilane; isopropenyl acetate; hydroxyl group-containing alpha-olefins such as 3-buten-1-ol, 4-penten-1-ol, 5-hexen-1-ol, 7-octen-1-ol, 9-decen-1-ol, and 3-methyl-3-buten-1-ol; carboxyl group-containing monomers such as fumaric acid, maleic acid, itaconic acid, maleic anhydride, and itaconic anhydride; sulfonic acid group-containing monomers such as ethylenesulfonic acid, allylsulfonic acid, methallylsulfonic acid, and 2-acrylamide-2-methylpropanesulfonic acid; cationic group-containing monomers such as vinyloxyethyltrimethylammonium chloride, vinyloxybutyltrimethylammonium chloride, vinyloxyethyldimethylamine, vinyloxymethyldiethylamine, N-acrylamidemethyltrimethylammonium chloride, 3-(N-methacrylamide)propyltrimethylammonium chloride, N-acrylamideethyltrimethylammonium chloride, N-acrylamidedimethylamine, allyltrimethylammonium chloride, methallyltrimethylammonium chloride, dimethylallylamine, and allylethylamine; acrylic acid, acrylic acid ester, acrylamide, and acrylamide derivatives. The amount of modification of the PVA (A) by a constituent unit derived from such a monomer is not particularly limited as long as the effects of the present invention are not impaired. Generally, however, it is 20 mol % or less and preferably 10 mol % or less, with respect to all the constituent units of the PVA (A).

The PVA (A) may be a terminal modified PVA obtained by the aforementioned polymerization and saponification that are carried out in the presence of a thiol compound such as thiol acetic acid, mercaptopropionic acid, or dodecylmercaptan.

The PVA (A) may be a modified PVA obtained by saponifying a polymer obtained by polymerizing vinyl ester monomers individually or together with ethylene and then further modifying it by the post-reaction, as long as the effects of the present invention are not impaired. Examples of such a modified PVA include various acetalized PVAs that are modified with aldehyde such as butylaldehyde, and acetoacetyl group-modified PVAs into which an acetoacetyl group has been introduced by using, for example, diketene. When the PVA (A) is a modified PVA, it is preferably an acetoacetyl group-modified PVA, that is, a PVA containing a constituent unit having an acetoacetyl group.

The amount of modification in the acetoacetyl group-modified PVA, that is, the content of the constituent units having acetoacetyl groups in this modified PVA, is preferably 8 mol % or less in general and more preferably 7 mol % or less. An excessively large amount of modification may deteriorate viscosity stability of the coating agent.

### [Addition Condensate (B)]

In the addition condensate (B) between ethylene urea and glyoxal, the content of the terminal aldehyde groups per gram of solid content is 1.2 to 3.0 (mmol: millimole). Hereinafter, the unit of the content of the terminal aldehyde groups per gram of solid content is indicated as (mmol/g-solid content).

The addition condensate (B) can be obtained by various production methods. For example, ethylene urea and glyoxal are mixed in a range of ethylene urea glyoxal=1:0.9 to 1.5 in terms of a molar ratio. Then, pH of the reaction system is adjusted, and an addition condensation reaction is allowed to proceed at a predetermined temperature to form the addition condensate (B).

The mixing ratio of ethylene urea and glyoxal that is used in obtaining the addition condensate (B) is preferably 0.9 to 1 mole of glyoxal to 1 mole of ethylene urea.

When the mixing ratio of ethylene urea and glyoxal is ethylene urea glyoxal=1 mole:more than 1.5 mole, it becomes highly probable that both terminals of the resultant addition condensate are aldehyde groups and thereby the viscosity stability of the coating agent deteriorates. Furthermore, in this case, an amount of glyoxal is excessive to ethylene urea, and this increases the amount of residual glyoxal remaining in the addition condensate and deteriorates the safety of the coating agent. The volatility of glyoxal is not as high as that of formaldehyde, which also is an aldehyde compound, but glyoxal has irritating properties with respect to the skin and mucosa of the human body and the mutagenicity thereof is positive. Therefore, from the safety viewpoint, a small amount of residual glyoxal is desired.

On the other hand, when the mixing ratio of ethylene urea and glyoxal is ethylene urea:glyoxal=1 mole:less than 0.9 mole, the amount of residual glyoxal in the addition condensate is reduced and thereby the safety of the coating agent is improved. However, it becomes highly probable that both terminals of the resultant addition condensate are amide groups, and thus water resistance of the resultant layer is deteriorated.

The content of the terminal aldehyde groups in the addition condensate (B) can be evaluated by the method described in JP 59-163497 A (U.S. Pat. No. 4,471,087) as shown in Examples. The content of the terminal aldehyde groups in the addition condensate (B) is preferably 1.5 to 2.4 (mmollg-solid content).

The amount of the residual glyoxal in the addition condensate (B) is generally 0.3 wt % or less in a solution in which the solid content concentration of the addition condensate (B) is 40 wt %.

Judging from the mutagenicity data of individual glyoxal described in “Mutagenicity test data of existing chemical substances” (issued by Japan Chemical Industry Ecology-Toxicology & Information Center, 1996), when the amount of the residual glyoxal in the addition condensate (B) is in the above-mentioned range, the mutagenicity derived from the residual glyoxal is negative.

Various conditions of the reaction system of the additional condensation between ethylene urea and glyoxal are not particularly limited. However, the temperature (reaction temperature) of the system is preferably 40 to 70° C. When the reaction temperature is lower than 40° C., the velocity of the reaction between both becomes excessively slow and the amount of residual glyoxal in the resultant addition condensate increases. On the other hand, when the reaction temperature exceeds 70° C., the coloring of the resultant addition condensate increases and the stability thereof is deteriorated.

Furthermore, for example, pH of the reaction system in which the addition condensation is carried out is preferably 4 to 7. When the pH of the system is lower than 4, the reaction of the addition condensation proceeds excessively, and thereby the stability of the resultant addition condensate is deteriorated. On the other hand, when the pH of the system exceeds 7, coloring of the resultant addition condensate increases and the stability thereof is deteriorated. The pH of the system in which the addition condensation is carried out can be adjusted with a pH adjuster. The pH adjuster is not particularly limited, and for example, sodium hydroxide, potassium hydroxide, sodium carbonate, ammonium carbonate, potassium carbonate, sodium phosphate, sodium hydrogen phosphate, ammonium phosphate, or ammonium hydrogen phosphate.

The addition condensate (B) is obtained as an aqueous solution through the above-mentioned reaction. It is preferable that ethylene urea and glyoxal be subjected to addition condensation in such a manner that the solid content concentration in the aqueous solution is 10 to 60 wt %. When the concentration exceeds 60 wt %, the viscosity of the resultant aqueous solution is high, and therefore the property of mixing with other materials is deteriorated and the stability thereof also is deteriorated. On the other hand, if the concentration is lower than 10 wt %, it takes time to form a layer when it is used as a coating agent. It is preferable that both be subjected to addition condensation in such a manner that the solid content concentration is 15 to 50 wt %.

The addition condensate (B) may be obtained as follows. Ethylene urea and glyoxal are mixed together in the range of ethylene urea:glyoxal=1:0.9 to 1 in terms of molar ratio, and after pH of the system in which addition condensation is carried out is adjusted to 4 to 7 with a pH adjuster, the reaction is allowed to proceed at 40 to 60° C.

### [Coating Agent for Paper]

The coating agent of the present invention contains the aforementioned PVA (A) and addition condensate (B) in the range of (A):(B)=99:1 to 50:50 in terms of solid content weight ratio. Since a layer can be formed that is further excellent in water resistance and that is subjected to further less yellowing over time, the weight ratio is preferably in the range of (A):(B)=98:2 to 60:40 and more preferably (A):(B)=97:3 to 65:35. When the solid content weight ratio of the addition condensate (B) is lower than the case of (A):(B)=99:1, the addition condensate (B) does not provide a sufficient effect as a crosslinker, and thereby a layer with sufficient water resistance is not formed. On the other hand, when the solid content weight ratio of the addition condensate (B) is higher than (A):(B)=50:50, the viscosity stability of the coating agent is deteriorated.

The coating agent of the present invention may contain various additives as required. Examples of the additives include water resistant agents such as polyvalent metal salt and water soluble polyamide resin; plasticizers such as glycols and glycerol; pH regulators such as ammonia, sodium hydroxide, sodium carbonate, and phosphoric acid; and antifoaming agents, mold release agents, and surfactants. As described above, however, in order to improve the safety of the coating agent, it is preferable that glyoxal as well as urea resin and melamine resin that may volatilize formaldehyde in use be not contained as additives.

The coating agent of the present invention also may contain the following additives in the range where the effects of the present invention are not impaired: for example, water soluble polymers such as starch, modified starch, casein, and carboxymethylcellulose; and synthetic resin emulsions such as styrene-butadiene latex, polyacrylic acid ester emulsion, vinyl acetate-ethylene copolymer emulsion, and vinyl acetate-acrylic acid ester copolymer emulsion.

The coating agent of the present invention can be used as, for example, a clear coating agent or a color developer (a pigment or a dye) coating agent. When the coating agent of the present invention is used as a clear coating agent, for example, the aforementioned coating layer can be formed on a paper surface. When it is used as a color developer coating agent, for example, the aforementioned color developing layer can be formed on a paper surface. The amount of the coating agent of the present invention to be used is not particularly limited and generally is about 0.1 to 30 g/m² in terms of solid content.

When the coating agent of the present invention is used as a clear coating agent, the type of the paper to be coated is not particularly limited. Examples of the paper include paper boards such as manila board, white board, and liner; and printing paper such as general high-quality paper, medium-quality paper, and gravure paper.

Similarly, when the coating agent of the present invention is used as a color developer coating agent, the type of the paper to be coated is not particularly limited. Examples of the paper include thermal paper, ink-jet printing paper, pressure-sensitive paper, art coated paper, and lightweight coated paper.

When the coating agent of the present invention is used as a clear coating agent, the coating agent is merely applied to the paper surface of the paper to be coated.

When the coating agent of the present invention is used as a color developer coating agent, a coating solution obtained by mixing the coating agent with a color developer is applied to the paper surface of the paper to be coated. The mixing ratio between the coating agent and the color developer is not particularly limited. Preferably, 0.5 to 15 parts by weight of the coating agent is mixed with 100 parts by weight of the color developer, and more preferably, 1 to 10 parts by weight of the coating agent is mixed therewith. The solid content concentration of the coating solution can be adjusted suitably in the range of 30 to 65 wt %.

Examples of the color developer to be mixed with the coating agent include pigments such as clay, kaolin, calcium carbonate, titanium white, and satin white.

The method of coating a paper surface with the coating agent of the present invention is not particularly limited. A known coater (a size press coater, an air knife coater, a blade coater, or a roll coater) may be used. After coating of the paper surface, optional processes such as a drying process and a calender process may be carried out as required. Thus, the paper (thermal paper) of the present invention can be obtained.

### EXAMPLES

Hereinafter, the present invention is described further in detail using examples. The present invention is not limited to the examples described below. The units “part” and “%” indicated in the examples are on the basis of weight unless otherwise specified.

### Synthesis of Addition Condensate Between Ethylene Urea and Glyoxal

### Synthesis Example 1

In a four-necked flask equipped with a reflux condenser, a thermometer, and a stirrer device, 86 parts of ethylene urea was placed, and 129 parts of water and 130.5 parts of solution of glyoxal with a concentration of 40% (equivalent to “ethylene urea:glyoxal=1:0.9” in terms of molar ratio) were added thereto. After pH of the system was adjusted to 7 using a solution of sodium hydroxide with a concentration of 10% as a pH adjuster, ethylene urea and glyoxal were allowed to react with each other at 60° C. for ten hours. After completion of the reaction, it was matured at 35° C. for 16 hours. Thereafter, the temperature of the system was lowered to 30° C. or lower and the pH of the system was adjusted to 6 using a solution of sulfuric acid with a concentration of 20%. Thus, a pale yellow transparent solution containing an addition condensate between ethylene urea and glyoxal was obtained. In this case, the addition condensate in the solution had a solid content concentration of 40%.

The average molecular weight of the addition condensate obtained as described above, the content of the terminal aldehyde groups in the addition condensate, and the amount of residual glyoxal in the solution were evaluated by the following methods. As a result, the average molecular weight (weight average molecular weight) was approximately 720, the content of the terminal aldehyde groups was 1.81 (mmol/g-solid content), and the amount of residual glyoxal was 0.1 wt %. The methods of evaluating these values are the same in the following synthesis examples.

### <Evaluation of Average Molecular Weight of Addition Condensate>

The average molecular weight of the addition condensate was determined by gel permeation chromatography (GPC). The conditions for the analysis were as follows.

Standard substance: polyethylene glycol, analyzer: LC-6A (manufactured by Shimadzu Corporation), column: HSP gel AQ2.5 (manufactured by Waters), column size: 6.0×150 mm, column temperature: 20° C., detector: RID-6A (manufactured by Shimadzu Corporation), elute: distilled water (manufactured by Wako Pure Chemical Industries, Ltd.), flow rate: 0.3 ml/min, injected sample concentration: 0.4 mg/mL, and the amount of injected sample: 5 μL.

### <Evaluation of the Amount of Residual Glyoxal in Solution>

The amount of residual glyoxal in the above-mentioned solution was determined by a high-performance liquid chromatography method. The conditions for the analysis were as follows.

Analyzer: LC-6A (manufactured by Shimadzu Corporation), column: Shim-pack CLC-ODS (manufactured by Shimadzu Corporation), column size: 6.0×150 mm, column temperature: 40° C., detector: RID-6A (manufactured by Shimadzu Corporation), elute: distilled water (manufactured by Wako Pure Chemical Industries, Ltd.), flow rate: 0.3 ml/min, injected sample concentration: 4.0 mg/mL, and the amount of injected sample: 5 μL.

### <Evaluation of the Content of Terminal Aldehyde Groups in Addition Condensate>

With reference to Bunseki Kagaku Benran (edited by The Japan Society for Analytical Chemistry, revised third edition, p. 314), the amount (wt %) of all aldehyde groups that are present in the aforementioned solution was determined by an acidic sodium sulfite process, and the amount (wt %) of the residual glyoxal determined as described above, which is indicated in terms of aldehyde groups, was subtracted from the amount of all aldehyde groups determined above. The value thus obtained was divided by the solid content concentration (wt %) of the addition condensate and the molecular weight (Mw=29) of the aldehyde groups. The value thus obtained was taken as the content (mmol/g-solid content) of the terminal aldehyde groups in the addition condensate.

The specific procedure of the acidic sodium sulfite process (direct process) is described below. One gram of sample, 5 mL of aqueous solution of sodium sulfite (NaHSO₃) with a concentration of 0.3 M, and 5 mL of water were mixed together. The mixture thus obtained was sealed and was allowed to stand for one hour. Subsequently, 0.5 mL of starch indicator was added to the mixture, which was then titrated immediately with a 0.1N I₂ solution. Then the amount (wt %) of all aldehyde groups that are present in the aforementioned solution can be determined from the amount A (mL) of the I₂ solution required for the titration by the following formula:

The amount of all aldehyde groups (wt %)=(A×0.1×29)/(2×1000)×100 (%)

### Synthesis Example 2

A pale yellow transparent solution containing an addition condensate between ethylene urea and glyoxal was obtained in the same manner as in Synthesis Example 1 except that 174 parts of solution of glyoxal with a concentration of 40% (equivalent to “ethylene urea:glyoxal=1:1.2” in terms of molar ratio) was used. The addition condensate in this solution had a solid content concentration of 40%.

The average molecular weight of the addition condensate obtained as described above, the content of the terminal aldehyde groups in the addition condensate, and the amount of the residual glyoxal in the solution were evaluated. As a result, the average molecular weight (weight average molecular weight) was approximately 820, the content of the terminal aldehyde groups was 2.16 (mmol/g-solid content), and the amount of the residual glyoxal was 0.3 wt %.

### Synthesis Example 3

A pale yellow transparent solution containing an addition condensate between ethylene urea and glyoxal was obtained in the same manner as in Synthesis Example 1 except that 188.5 parts of solution of glyoxal with a concentration of 40% (equivalent to “ethylene urea:glyoxal=1:1.3” in terms of molar ratio) was used. The addition condensate in this solution had a solid content concentration of 40%.

The average molecular weight of the addition condensate obtained as described above, the content of the terminal aldehyde groups in the addition condensate, and the amount of the residual glyoxal in the solution were evaluated. As a result, the average molecular weight (weight average molecular weight) was approximately 880, the content of the terminal aldehyde groups was 2.41 (mmol/g-solid content), and the amount of the residual glyoxal was 0.5 wt %.

### Synthesis Example 4

In a four-necked flask similar to that used in Synthesis Example 1, 86 parts of ethylene urea was placed, and 129 parts of water and 111.7 parts of solution of glyoxal with a concentration of 40% (equivalent to “ethylene urea:glyoxal=1:0.77” in terms of molar ratio) were then added thereto. After pH of the system was adjusted to 7.5 using a solution of sodium hydroxide with a concentration of 10% as a pH adjuster, this was stirred at 55° C. for one hour. Subsequently, after the pH of the system was adjusted to 6.5 using sulfuric acid with a concentration of 20% as a pH adjuster, ethylene urea and glyoxal were allowed to react with each other at 55° C. for 1.5 hours. After completion of the reaction, the temperature of the system was lowered to 30° C. or lower and the pH of the system was adjusted to 7 using a solution of sodium hydroxide with a concentration of 25%. Thereafter, water was added thereto so that a solid content concentration of 40% was obtained. Thus, a pale yellow transparent solution containing an addition condensate between ethylene urea and glyoxal was obtained.

The average molecular weight of the addition condensate obtained as described above, the content of the terminal aldehyde groups in the addition condensate, and the amount of the residual glyoxal in the solution were evaluated. As a result, the average molecular weight (weight average molecular weight) was approximately 650, the content of the terminal aldehyde groups was 0.78 (mmol/g-solid content), and the amount of the residual glyoxal was not detected.

### Synthesis Example 5

A pale yellow transparent solution containing an addition condensate between ethylene urea and glyoxal was obtained in the same manner as in Synthesis Example 4 except that 116.0 parts of solution of glyoxal with a concentration of 40% (equivalent to “ethylene urea:glyoxal=1:0.8” in terms of molar ratio) was used. The addition condensate in this solution had a solid content concentration of 40%.

The average molecular weight of the addition condensate obtained as described above, the content of the terminal aldehyde groups in the addition condensate, and the amount of the residual glyoxal in the solution were evaluated. As a result, the average molecular weight (weight average molecular weight) was approximately 700, the content of the terminal aldehyde groups was 1.21 (mmol/g-solid content), and the amount of the residual glyoxal was not detected.

### Synthesis Example 6

A pale yellow transparent solution containing an addition condensate between ethylene urea and glyoxal was obtained in the same manner as in Synthesis Example 1 except that 290.0 parts of solution of glyoxal with a concentration of 40% (equivalent to “ethylene urea:glyoxal=1:2.0” in terms of molar ratio) was used. The addition condensate in this solution had a solid content concentration of 40%.

The average molecular weight of the addition condensate obtained as described above, the content of the terminal aldehyde groups in the addition condensate, and the amount of the residual glyoxal in the solution were evaluated. As a result, the average molecular weight (weight average molecular weight) was approximately 1150, the content of the terminal aldehyde groups was 3.71 (mmol/g-solid content), and the amount of the residual glyoxal was 0.4 wt %.

The contents of the terminal aldehyde groups and the amounts of the residual glyoxal in Synthesis Examples 1 to 6 are indicated in Table 1 below together with the mixing ratios of ethylene urea and glyoxal.

TABLE 1

| | Mixing Ratio | | |
|---|---|---|---|
| | (Molar Ratio) | Content of Terminal | Amount of |
| | Ethylene Urea/ | Aldehyde Groups | Residual Glyoxal |
| | Glyoxal | (mmol/g · solid content) | (wt %) |
| Synthesis | 1/0.9 | 1.81 | 0.1 |
| Example 1 | | | |
| Synthesis | 1/1.2 | 2.16 | 0.3 |
| Example 2 | | | |
| Synthesis | 1/1.3 | 2.41 | 0.5 |
| Example 3 | | | |
| Synthesis | 1/0.77 | 0.78 | Not detected |
| Example 4 | | | |
| Synthesis | 1/0.8 | 1.21 | Not detected |
| Example 5 | | | |
| Synthesis | 1/2.0 | 3.71 | 0.4 |
| Example 6 | | | |

### [Synthesis of PVA]

### <PVA-1>

In a pressurized reaction vessel with an internal volume of 250 L that is provided with a stirrer, a nitrogen feed port, an ethylene feed port, a port for adding a polymerization initiator, and a port for adding a delay solution, 130.5 kg of vinyl acetate monomers and 19.5 kg of methanol were placed. After the temperature inside the vessel was increased to 60° C., the inside of the reaction system was subjected to nitrogen substitution by nitrogen bubbling carried out for 30 minutes. Subsequently, ethylene gas was introduced into the vessel so that the pressure inside the reaction vessel reached 0.39 MPa. Thereafter, 90 mL of methanol solution of AMV (2,2′-azobis(4-methoxy-2,4-dimethylvaleronitrile)) (with a concentration of 2.8 g/L, which had been subjected to nitrogen substitution by nitrogen bubbling) was added, as a polymerization initiator, to the mixture of vinyl acetate monomers and methanol inside the reaction vessel, and thereby copolymerization between vinyl acetate monomers and ethylene was initiated. During the polymerization, the temperature inside the vessel was maintained at 60° C. and the above-mentioned AMV solution was fed continuously, as a polymerization initiator, into the vessel at a rate of 135 mL/h.

Approximately 4 hours later when the polymerization rate reached 40%, the reaction system was cooled and thereby the polymerization reaction was stopped. During the polymerization, the pressure inside the vessel decreased gradually, and the pressure was 0.37 MPa when the polymerization was stopped.

Next, the reaction vessel was opened and ethylene was removed from the inside of the vessel. Thereafter, the inside of the reaction system was subjected to deethylenation by nitrogen bubbling. Subsequently, methanol vapor was introduced into the reaction vessel, and unreacted vinyl acetate monomers remaining inside the reaction system were discharged. Thus, a methanol solution of polyvinyl acetate (ethylene-modified polyvinyl acetate) (with a concentration of 40%) containing an ethylene unit as a constituent unit was obtained.

Next, methanol was added to the resultant solution to adjust it so that the polyvinyl acetate in the solution had a concentration of 30%. Thereafter, 23.7 g of alkaline solution (a methanol solution of sodium hydroxide with a concentration of 10%) was added to 1000 g of the solution thus adjusted (containing 300 g of the above-mentioned polyvinyl acetate) (the molar ratio of sodium hydroxide to a vinyl acetate unit was 0.017), and thereby ethylene-modified polyvinyl acetate was saponified. In this case, the saponification was carried out at a temperature of 40° C.

The whole solution was gelled in approximately two minutes after addition of the alkaline solution. The gel thus formed was removed from the reaction vessel and was ground with a grinder. This was allowed to stand at 40° C. for one hour to further be saponified. Thereafter, residual sodium hydroxide was neutralized with methyl acetate. After the completion of neutralization was checked with a phenolphthalein indicator, a white solid obtained through filtering out was put into methanol whose amount was five times the amount of the white solid to be washed. This was allowed to stand at room temperature for three hours. Subsequently, the washing operation including filtering out and putting the white solid obtained through the filtering out into methanol was repeated three times. Thereafter, the white solid obtained by centrifugation was allowed to stand in a dryer kept at 70° C. for one day to be dried. Thus, an ethylene-modified PVA (PVA-1) was obtained. The degree of polymerization, the content X of vinyl alcohol units (mol %), and the content Y of ethylene units (mol %) in the PVA-lwere evaluated based on the provision of JIS K6726 (The test methods for polyvinyl alcohol) and the aforementioned method using ¹H-NMR. As a result, the degree of polymerization was 1500, the content X was 97.5 mol %, and the content Y was 3.0 mol %.

### <PVA-2 to PVA-17>

The conditions for polymerizing vinyl acetate monomers and/or the conditions for saponification were varied, and thereby 16 types of PVAs (PVA-2 to PVA-17) were obtained that were different from the PVA-1 in at least one selected from the degree of polymerization, the content X, and the content Y. The degree of polymerization, the content X, and the content Y in each of the PVAs synthesized above including the PVA-1 are indicated together in Table 2 below. The PVA-11 to PVA-13 were produced by allowing the polymerization reaction to proceed without introducing ethylene gas into the reaction vessel.

TABLE 2

| | | Content X of | Content Y of | |
|---|---|---|---|---|
| | Degree of | Vinyl Alcohol | Ethylene | |
| | Polymerization | Units (mol %) | Units (mol %) | X + 0.2Y |
| PVA-1 | 1500 | 97.5 | 3.0 | 98.1 |
| PVA-2 | | 98.5 | | 99.1 |
| PVA-3 | | 99.5 | | 100.1 |
| PVA-4 | | 99.3 | 5.0 | 100.3 |
| PVA-5 | | 98.5 | | 99.5 |
| PVA-6 | | 97.0 | | 98.0 |
| PVA-7 | | 94.5 | | 95.5 |
| PVA-8 | 500 | 98.5 | 9.0 | 100.3 |
| PVA-9 | | 96.5 | | 98.3 |
| PVA-10 | | 94.0 | | 95.8 |
| PVA-11 | 1750 | 99.5 | 0 | 99.5 |
| PVA-12 | | 98.5 | | 98.5 |
| PVA-13 | | 94.5 | | 94.5 |
| PVA-14 | 1500 | 94.0 | 3.0 | 94.6 |
| PVA-15 | | 93.5 | 5.0 | 94.5 |
| PVA-16 | | 99.9 | | 100.9 |
| PVA-17 | 500 | 92.5 | 9.0 | 94.3 |

### Production of Coating Agent

### Example 1

Ninety grams of aluminum hydroxide powder (HIGILITE H42, manufactured by Showa Denko K.K.) was put into 210 g of distilled water, which was then stirred manually. Thereafter, this was stirred with a homomixer (T-25-SI, manufactured by IKA-Labortechnik) at a rotation speed of 13500 rpm for five minutes. Thus, an aluminum hydroxide dispersion solution A (with an aluminum hydroxide concentration of 30%) was prepared.

Separately, the PVA-1 was dissolved in hot water at 95° C., and thereby a aqueous solution of PVA with a concentration of 10% was prepared.

Next, 60 g of the PVA aqueous solution was added to 22 g of the dispersion solution A. After they were mixed together homogeneously, further Synthesis Example 1 was added thereto as an addition condensate in such a manner that the ratio of PVA:addition condensate (solid content weight ratio) was 90:10, which was then mixed together homogeneously. Thereafter, distilled water was added thereto so that a solid content concentration of 15% was obtained. Thus, a coating agent (Example 1) was obtained. The viscosity of the coating agent thus obtained was measured with a B-type viscometer at a temperature of 20° C., with the rotation speed of the inner cylinder being 60 rpm, and was determined to be 480 mPa·s.

The viscosity stability of the coating agent obtained above was evaluated by the following method. The evaluation results are indicated in Table 3 below.

### [Viscosity Stability]

The coating agent obtained as described above was allowed to stand at a temperature of 20° C. for 20 hours and then the viscosity thereof after standing was measured with the B-type viscometer in the same manner as described above. The ratio of the viscosity to the initial viscosity was determined as a viscosity increase ratio (=viscosity after standing/initial viscosity). The viscosity stability of the coating agent was evaluated on a 3-point scale described below, based on the value of the viscosity increase ratio determined above.

### —Criteria for Judging Viscosity Stability—

∘ (Good): The viscosity increase ratio was lower than 1.5.
Δ (Acceptable): The viscosity increase ratio was 1.5 or higher but lower than 3.0.
x (Unacceptable): The viscosity increase ratio was 3.0 or higher.

Next, the coating agent obtained as described above was applied manually onto a paper surface of commercial thermal paper (manufactured by Kokuyo Co., Ltd.) with a wire bar No. 14 (manufactured by ETO). Thereafter, the coated surface was dried with a hot air dryer at 50° C. for five hours. Subsequently, the thermal paper thus dried was allowed to stand for three hours in a room adjusted to 20° C. and 65% RH. This was used as a sample for evaluating the properties (water resistance, blocking resistance, plasticizer resistance, and the degree of yellowing over time) of the layer formed of the coating agent.

### [Water Resistance]

After the above-mentioned sample was immersed in water at 40° C. for 24 hours, the coated surface was rubbed with a finger ten times and the state of peeling produced at the surface was then observed. The water resistance of the layer formed of the coating agent was evaluated on a 5-point scale by judging the state thus observed according to the following criteria.

### —Criteria for Judging Water Resistance—

5: No peeling of the surface was observed.
4: A very little peeling of the surface was observed.
3: A little peeling of the surface was observed.
2: Much peeling of the surface was observed.
1: Most part of the surface was peeled.

### [Blocking Resistance (Surface Water Resistance)]

The above-mentioned sample was allowed to stand in an atmosphere with a temperature of 40° C. for 72 hours and was then cut into five centimeters square pieces. Subsequently, a drop (about 30 μL) of water was dropped on the coated surface. Thereafter, another sample on which no waterdrop was dropped was then placed thereon so that the coated surfaces of both were in contact with each other, which was then subjected to natural drying. After drying, the samples were separated from each other and their conditions after separation were observed. The blocking resistance of the layer formed of the coating agent was evaluated on a 3-point scale by judging the condition thus observed according to the following criteria.

### —Criteria for Judging Blocking Resistance—

3: Samples were separated spontaneously without any force being applied.
2: Surfaces adhered partially to each other but no tears were caused in the samples.
1: Surfaces adhered to each other and the samples were torn upon separation

### [Plasticizer Resistance]

Printing was carried out with a commercial thermal paper facsimile (RIFAX 300, manufactured by Ricoh Company, Ltd.), with the coated surface of the above-mentioned sample being used as a printing surface. Subsequently, a wrap film (HI-WRAP SAS, manufactured by Mitsui Chemicals, Inc.) was wound three times around a polycarbonate pipe (with a diameter of 40 mm), and the above-mentioned printed sample was then wound thereon. Thereafter, further the above-mentioned wrap film was wound three times thereon. This was then allowed to stand in an atmosphere with a temperature of 40° C. for 24 hours, and the printing density after standing was measured with a Macbeth densitometer. Thus, the plasticizer resistance of the layer formed of the coating agent was evaluated. Larger numerical values indicated in Table 3 denote that the printing density was maintained, that is, the plasticizer resistance of the layer formed of the coating agent is high.

### [The Degree of Yellowing Over Time]

Printing was carried out with the above-mentioned thermal paper facsimile, with the coated surface of the above-mentioned sample being used as a printing surface. Subsequently, the printed sample was allowed to stand in a thermo-hygrostat adjusted to 40° C. and 95% RH for three weeks. The color tone of the sample after standing was measured with a colorimeter (PF-10, manufactured by NDK, Incorporated), and the b-value was evaluated as a measure that indicates the yellow tinge thereof. Larger numerical values of the b-value denote stronger degrees of yellow, that is, advanced yellowing.

### Examples 2 to 20 and Comparative Examples 1 to 10

The addition condensates formed as Synthesis Examples 1 to 6 and PVA-1 to PVA-17 were mixed together at the ratios indicated in Tables 3A and 3B below in the same manner as in Example 1, and thereby coating agents (Examples 2 to 20 and Comparative Examples 1 to 10) were obtained. In Comparative Example 8, glyoxal was used as a crosslinker instead of the addition condensate.

The viscosity stability of the coating agents thus obtained and properties of the layers formed of the coating agents were evaluated in the same manner as in Example 1. The evaluation results are indicated in Tables 3A and 3B below.

TABLE 3A

| | Composition of Coating Agent | | | Properties of | | | | | |
|---|---|---|---|---|---|---|---|---|---|
| | | | Mixing Ratio of PVA | Coating Agent | | | | | |
| | | | and Addition Condensate | Initial | | Properties of Layer formed of Coating Agent | | | |
| | | | (Solid Content Weight Ratio) | Viscosity | Viscosity | Water | Blocking | Plasticizer | |
| | PVA | Addition Condensate | PVA: Addition Condensate | (mPa · s) | Stability | Resistance | Resistance | Resistance | b-value |
| Example 1 | PVA-1 | Synthesis Example 1 | 90:10 | 480 | ∘ | 4 | 3 | 1.4 | 2.8 |
| Example 2 | | Synthesis Example 2 | | 480 | ∘ | 4 | 3 | 1.4 | 2.8 |
| Example 3 | | Synthesis Example 3 | | 480 | ∘ | 4 | 3 | 1.4 | 3.5 |
| Example 4 | | Synthesis Example 5 | | 480 | ∘ | 3 | 3 | 1.4 | 2.8 |
| Example 5 | PVA-2 | Synthesis Example 1 | | 480 | ∘ | 4 | 3 | 1.4 | 2.8 |
| Example 6 | PVA-3 | | | 480 | ∘ | 5 | 3 | 1.4 | 2.8 |
| Example 7 | PVA-4 | | | 480 | ∘ | 5 | 3 | 1.4 | 2.8 |
| Example 8 | | Synthesis Example 2 | | 480 | ∘ | 5 | 3 | 1.4 | 2.8 |
| Example 9 | | Synthesis Example 3 | | 480 | ∘ | 5 | 3 | 1.4 | 3.5 |
| Example 10 | PVA-5 | Synthesis Example 1 | | 480 | ∘ | 3 | 2 | 1.4 | 2.8 |
| Example 11 | PVA-6 | | | 480 | ∘ | 3 | 2 | 1.4 | 2.8 |
| Example 12 | PVA-7 | | | 480 | ∘ | 3 | 2 | 1.4 | 2.8 |
| Example 13 | PVA-8 | | | 230 | Δ | 5 | 3 | 1.2 | 2.8 |
| Example 14 | | Synthesis Example 2 | | 230 | ∘ | 5 | 3 | 1.2 | 2.8 |
| Example 15 | | Synthesis Example 3 | | 230 | ∘ | 5 | 3 | 1.2 | 3.5 |
| Example 16 | PVA-9 | Synthesis Example 1 | | 230 | Δ | 3 | 2 | 1.2 | 2.8 |
| Example 17 | PVA-10 | | | 230 | Δ | 3 | 2 | 1.2 | 2.8 |
| Example 18 | PVA-11 | | | 480 | ∘ | 3 | 2 | 1.4 | 2.8 |
| Example 19 | PVA-12 | | | 480 | ∘ | 3 | 2 | 1.4 | 2.8 |
| Example 20 | PVA-1 | | 60:40 | 830 | Δ | 4 | 3 | 1.4 | 3 |

TABLE 3B

| | Composition of Coating Agent | | | | | | | | |
|---|---|---|---|---|---|---|---|---|---|
| | | | Mixing Ratio of PVA | Properties of Coating Agent | | | | | |
| | | | and Addition Condensate | Initial | | Properties of Layer formed of Coating Agent | | | |
| | | Addition | (Solid Content Weight Ratio) | Viscosity | Viscosity | Water | Blocking | Plasticizer | |
| | PVA | Condensate | PVA: Addition Condensate | (mPa · s) | Stability | Resistance | Resistance | Resistance | b-value |
| Comparative | PVA-13 | Synthesis | 90:10 | 450 | ∘ | 1 | 1 | 1.4 | 2.8 |
| Example 1 | | Example 1 | | | | | | | |
| Comparative | PVA-14 | | | 480 | ∘ | 1 | 1 | 1.4 | 2.8 |
| Example 2 | | | | | | | | | |
| Comparative | PVA-15 | | | 480 | ∘ | 1 | 1 | 1.4 | 2.8 |
| Example 3 | | | | | | | | | |
| Comparative | PVA-16 | | | 620 | x | 5 | 3 | 1.4 | 2.8 |
| Example 4 | | | | | | | | | |
| Comparative | PVA-17 | | | 220 | x | 1 | 1 | 1.2 | 2.8 |
| Example 5 | | | | | | | | | |
| Comparative | PVA-1 | Synthesis | | 480 | ∘ | 1 | 1 | 1.4 | 2.8 |
| Example 6 | | Example 4 | | | | | | | |
| Comparative | | Synthesis | | 480 | x | 5 | 3 | 1.4 | 4.1 |
| Example 7 | | Example 6 | | | | | | | |
| Comparative | | Glyoxal | — | 480 | ∘ | 1 | 2 | 1.4 | 5.1 |
| Example 8 | | | | | | | | | |
| Comparative | | Synthesis | 99.5:0.5 | 460 | ∘ | 2 | 1 | 1.4 | 2.8 |
| Example 9 | | Example 1 | | | | | | | |
| Comparative | | | 40:60 | 1080 | x | 4 | 3 | 1.4 | 3.4 |
| Example 10 | | | | | | | | | |

As indicated in Tables 3A and 3B, in Examples 1 to 20 of the coating agents of the present invention, the viscosity stability thereof and various properties of the layers formed using the coating agents were expressed in a well balanced manner at a high level.

Among Examples 1 to 20, Examples 6 to 9 and 13 to 15 in which the value of “X+0.2Y” exceeded 100 made it possible to form layers having further higher water resistance.

On the other hand, the values of “X+0.2Y” in Comparative Examples 1 to 3 and 5, the content X of vinyl alcohol units in Comparative Example 4, the contents of the terminal aldehyde groups in the addition condensates in Comparative Examples 6 and 7, and the mixing ratios of PVA and addition condensate in Comparative Examples 9 and 10 were out of the ranges specified in the present invention and the above-mentioned properties were not expressed in a well balanced manner. More specifically, they were poor in water resistance and blocking resistance or were subjected to deterioration in the viscosity stability of the coating agent. Furthermore, in Comparative Example 7 using the addition condensate (Synthesis Example 6) in which the content of the terminal aldehyde groups was larger than the range specified in the present invention, the degree of yellowing over time increased in addition thereto.

Moreover, in Comparative Example 8 in which glyoxal was used as a crosslinker, it was poor in water resistance and the degree of yellowing over time increased significantly.

The present invention is applicable to other embodiments as long as they do not depart from the spirit and essential characteristics thereof. The embodiments disclosed in this specification are to be considered in all respects as illustrative and not limiting. The scope of the present invention is indicated by the appended claims rather than by the foregoing description, and all changes that come within the meaning and range of equivalency of the claims are intended to be embraced therein.

### INDUSTRIAL APPLICABILITY

As described above, the use of a coating agent for paper of the present invention allows a curing step to be omitted after a paper surface is coated therewith and makes it possible to form a layer (for example, a coating layer or a color developing layer) that is excellent in water resistance and is subjected to less yellowing over time. That is, paper having a layer (for example, a coating layer or a color developing layer) that is excellent in water resistance and is subjected to less yellowing over time can be produced, and the paper is excellent in, for example, water resistance, image record retention properties, plasticizer resistance, and productivity and can be used suitably for various printing methods including offset printing and thermal printing.

1. A coating agent for paper comprising:
a vinyl alcohol polymer (A) in which the content X of a vinyl alcohol unit (mol %) and the content Y of an ethylene unit (mol %) satisfy the following formula (1):
X+0.2Y>95 (1)
where X<99.9 and 0≦Y<10; and
an addition condensate (B) between ethylene urea and glyoxal in which the content of a terminal aldehyde group per gram of solid content is 1.2 to 3.0 (mmol),
wherein the solid content weight ratio between the vinyl alcohol polymer (A) and the addition condensate (B) is in a range of (A):(B)=99:1 to 50:50.

2. The coating agent for paper according to claim 1, wherein the vinyl alcohol polymer (A) satisfies the following formula (2) with respect to the contents X and Y:
X+0.2Y>98.5 (2)
where X<99.9 and 0≦Y<10.

3. The coating agent for paper according to claim 1, wherein the vinyl alcohol polymer (A) contains an ethylene unit.

4. Paper having a surface coated with a coating agent for paper according to claim 1.

5. Thermal paper having a surface coated with a coating agent for paper according to claim 1.
